(19) United States
(12) Patent Application Publication
(10) Pub. No.: US 2014/0126463 A1
(43) Pub. Date: May 8, 2014

(54) COMMUNICATION SYSTEM AND COMMUNICATION METHOD

(71) Applicant: KABUSHIKI KAISHA TOSHIBA, Tokyo (JP)

(72) Inventor: Masahiro ISHIYAMA, Kanagawa (JP)

(73) Assignee: KABUSHIKI KAISHA TOSHIBA, Tokyo (JP)

(21) Appl. No.: 14/074,233

(22) Filed: Nov. 7, 2013

(30) Foreign Application Priority Data
Nov. 8, 2012 (JP) 2012-246717

(51) Int. Cl. H04W 76/04; H04B 7/14

(52) U.S. Cl. CPC H04W 76/04; H04B 7/14
USPC 370/315

(57) ABSTRACT

According to an embodiment, a communication system includes a first relay device located outside of a firewall; and a second relay device located within the firewall. The first relay device includes a first receiving unit to receive a request for acquiring information on an information processing device within the firewall from a communication device and receive the information acquired from the information processing device from the second relay device; and a first transmitting unit to transmit the acquisition request to the second relay device and transmit the information received from the second relay device to the communication device. The second relay device includes a second receiving unit to receive the acquisition request; an acquiring unit to acquire information requested by the acquisition request from the information processing device; and a second transmitting unit to transmit the acquired information to the first relay device.

### CROSS-REFERENCE TO RELATED APPLICATION(S)

This application is based upon and claims the benefit of priority from Japanese Patent Application No. 2012-246717, filed on Nov. 8, 2012; the entire contents of which are incorporated herein by reference.

### FIELD

Embodiments described herein relate generally to a communication system and a communication method.

### BACKGROUND

The Internet that is the world's largest computer network has been widely used. New computer businesses using information and services available to the public by connecting to the Internet and, conversely, providing information and services to external users accessing via the Internet have been developed. Furthermore, new technologies in relation to utilization of the Internet are being developed and deployed.

Similarly, in networks (control networks) to which sensors and actuators are connected in buildings and factories, there has been an increasing trend toward networking using the Internet Protocol (IP networking). For example, there has been an increasing move to connect such low-cost embedded devices typified by sensors to networks and acquire and utilize various information items on the embedded devices via the networks.

Furthermore, web service technologies have also come to be used in facility networks as typified by BACnet/WS (a data communication protocol for building automation and control network/web services). The web service technologies are expected to be utilized for operation of an existing facility network and an IT system in conjunction with each other. The IT system can obtain facility equipment information through web services.

Existing facility equipment cannot communicate directly through web services. Thus, a gateway for converting the protocol for the facility network is provided therebetween, and IT equipment and the like acquire and set information on the facility equipment by communicating with the gateway.

When, however, utilization in small and medium-sized enterprises is particularly considered, it is difficult to install dedicated lines for the facility networks to connect to the Internet. It is therefore desirable in terms of cost to use an existing OA network, for example. In an OA network, however, a firewall (or a NAT) is usually present. It is therefore difficult to be accessed from a server located on the Internet (outside of the firewall) and configured to manage facility equipment. Furthermore, there are various policies on operation of an OA network to be used. Thus, there are concerns about increase in the engineering cost for providing support for each of the various operation policies.

### BRIEF DESCRIPTION OF THE DRAWINGS

FIG. 1 is a block diagram of a communication system according to an embodiment;

FIG. 2 is a block diagram of a CS according to the embodiment;

FIG. 3 is a block diagram of a BS according to the embodiment;

FIG. 4 is a block diagram of a FG according to the embodiment;

FIG. 5 is a block diagram of a RS according to the embodiment;

FIG. 6 is a sequence diagram of a startup process according to the embodiment;

FIG. 7 is a sequence diagram of a data collection process according to the embodiment;

FIG. 8 is a sequence diagram of a data collection process according to the embodiment;

FIG. 9 is a sequence diagram of a data collection process according to the embodiment;

FIG. 10 is a sequence diagram of a data collection process according to the embodiment; and

FIG. 11 is a hardware configuration diagram of the communication system according to the embodiment.

### DETAILED DESCRIPTION

According to an embodiment, a communication system includes a first relay device located outside of a firewall; and a second relay device located within the firewall. The first relay device includes a first receiving unit configured to receive a request for acquiring information on an information processing device within the firewall from a communication device and receive the information acquired from the information processing device from the second relay device; a storage unit configured to store therein the acquisition request; and a first transmitting unit configured to transmit the acquisition request stored in the storage unit to the second relay device and transmit the information received from the second relay device to the communication device. The second relay device includes a second receiving unit configured to receive the acquisition request transmitted from the first relay device; an acquiring unit configured to acquire information requested by the acquisition request from the information processing device; and a second transmitting unit configured to transmit the acquired information to the first relay device.

A preferred embodiment of a communication system will be described in detail below with reference to the accompanying drawings. Although an example of a communication system configured to collect information on facility equipment like a facility network, systems to which the communication system can be applied are not limited thereto. The communication system can be applied to any system configured to collect information on information processing devices (such as facility equipment) within a firewall from outside of the firewall.

The communication system according to the embodiment includes, in addition to a crawler server (CS) and a facility gateway (FG), a broker server (BS) configured to function as a first relay device, and a relay server (RS) configured to function as a second relay device. The crawler server is a communication device configured to collect information from information processing devices (facility equipment) within a firewall. The facility gateway is a device configured to convert protocols to be used by the facility equipment.

The broker server is a server located on the Internet (outside of the firewall) and configured to secure message switching between the crawler server and the second relay device. The relay server is located within the firewall and configured to relay communication between the facility gateway and the broker server.

In the following, the crawler server, the facility gateway, the broker server, and the relay server may also be referred to as CS, FG, BS, and RS, respectively.

If the FG seeks always-on connection with a device outside of the firewall (and if the always-on connection is permitted), the RS performs always-on connection (longpoll) to the BS. In an environment in which always-on connection is not permitted, the RS periodically polls the BS (intermittent connection).

The BS temporarily holds the request from the CS, and passes the request to the RS while the RS connects thereto. The RS performs message switching between the FG and the BS.

The RS and the CS may exchange connection information such as a crawling interval via the BS to adjust the timing of information acquisition. The RS performing intermittent connection may periodically pass information expected to be necessary from a history of previous requests from the CS to the BS.

With such a configuration as described, above, an embodiment in which the RS located within the firewall accesses the BS located outside of the firewall can be achieved. It is therefore possible to solve the problem that it is difficult to be accessed from a device on the Internet because of the presence of the firewall. Furthermore, it is possible to use existing web service technologies without any change at both of the CS and the FG.

Furthermore, each of a FG capable of communicating directly with the CS, a FG located within the firewall but permitted to perform always-on connection, and a FG located within the firewall and permitted to perform only intermittent connection (for example, only normal HTTP GET is permitted) can be handled similarly. That is, various operation policies of networks to be used can be easily supported. Furthermore, if the timing of acquiring information by parameter switching or the like can be adjusted, crawling can be more efficient.

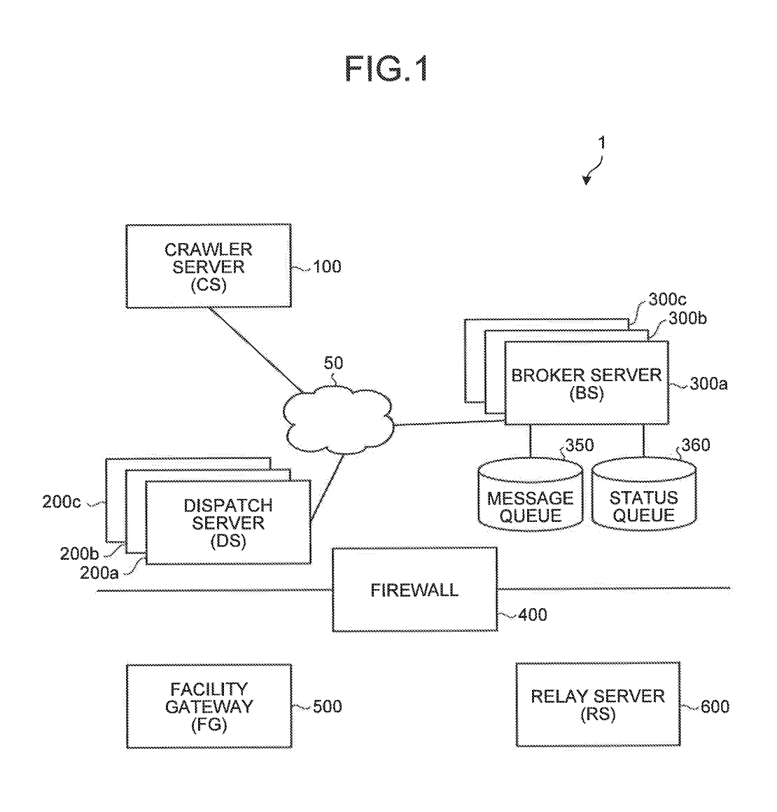

FIG. 1 is a block diagram illustrating an example of a communication system 1 according to the embodiment. As illustrated in FIG. 1, the communication system 1 includes a crawler server (CS) 100, dispatch servers (DS) 200a to 200c, broker servers (BS) 300a to 300c, a firewall (FW) 400, a facility gateway (FG) 500, and a relay server (RS) 600.

The CS 100, the DSs 200a to 200c, and the BSs 300a to 300c are located outside of the FW 400 and connected via the Internet 50. The FG 500 and the RS 600 are located within the FW 400.

The CS 100 is a communication device configured to collect information on facility equipment (not illustrated) and the like within the FW 400. Although only one CS 100 is illustrated in FIG. 1 for explanation, the communication system 1 may include a plurality of CSs 100.

The FG 500 is present on a network within the FW 400 and configured to manage information on the facility equipment. The FG 500 provides information and receives an operation request in a web service protocol. An original endpoint reference (oEPR) indicating a service to be provided is assigned to the FG 500. Although only one FG 500 is illustrated in FIG. 1, the communication system 1 may include a plurality of FGs 500. Services provided by a plurality of FGs 500 are distinguished from one another by using the oEPRs, for example.

The BSs 300a to 300c are servers configured to relay communication (typically SOAP messages) between the FG 500 (RS 600) and the CS 100. Since the BSs 300a to 300c have the same configuration, the BSs may be simply referred to as BSs 300 when it is not necessary to distinguish them. Although three BSs 300 are illustrated in FIG. 1, the number of BSs 300 is not limited to three.

Relay endpoint references (rEPR) are assigned to the respective BSs 300. Furthermore, each of the BSs 300 includes a message queue (MQ) 350 and a status queue (SQ) 360 that function as storage units.

The MQ 350 is a queue included in the BS 300, the number of the MQs being one for each oEPR for which the BS 300 relays communication. The MQ 350 holds messages to be transmitted/received to/from the FG 500 and the CS 100. Since the MQ 350 has directionality, the MQ 350 actually includes two queues saving messages from the FG 500 to the CS 100 and messages from the CS 100 to the FG 500, respectively.

Note that the queue to be read by the FG 500 is the queue (referred to as MQ 350-1) in which messages from the CS 100 to the FG 500 are saved. The queue to be written by the FG 500 is the queue (referred to as MQ 350-2) in which messages from the FG 500 to the CS 100 are saved. The queue to be read by the CS 100 and the queue to be written by the CS 100 are opposite thereto, which are the MQ 350-2 and the MQ 350-1, respectively. Furthermore, the MQ 350 may also save additional information (such as reception time) accompanying each message together with the message.

The SQ 360 is a queue included in the BS 300, the number of the SQs being one for each oEPR for which the BS 300 relays communication. The SQ 360 saves statuses (states) of the FG 500 and the CS 100. The SQ 360 includes two queues, which are a queue saving statuses of the FG 500 and a queue saving statuses of the CS 100.

Note that the queue to be read by the FG 500 is the queue (referred to as SQ 360-1) in which statuses of the CS 100 are saved. The queue to be written by the FG 500 is the queue (referred to as SQ 360-2) in which statuses of the FG 500 are saved. The queue to be read by the CS 100 and the queue to be written by the CS 100 are opposite thereto, which are the SQ 360-2 and the SQ 360-1, respectively.

The DSs 200a to 200c have functions of instructing the BS 300 that handles each oEPR. Since the DSs 200a to 200c have the same functions, the DSs may be simply referred to as DSs 200 when it is not necessary to distinguish them. Although three DSs 200 are illustrated in FIG. 1, the number of DSs 200 is not limited to three.

The RS 600 is present on the network within the FW 400 and relays communication between the FG 500 and the BSs 300. Although only one RS 600 is illustrated in FIG. 1, the communication system 1 may include a plurality of RSs 600.

The FW 400 has functions similar to those of a firewall typically used for the Internet.

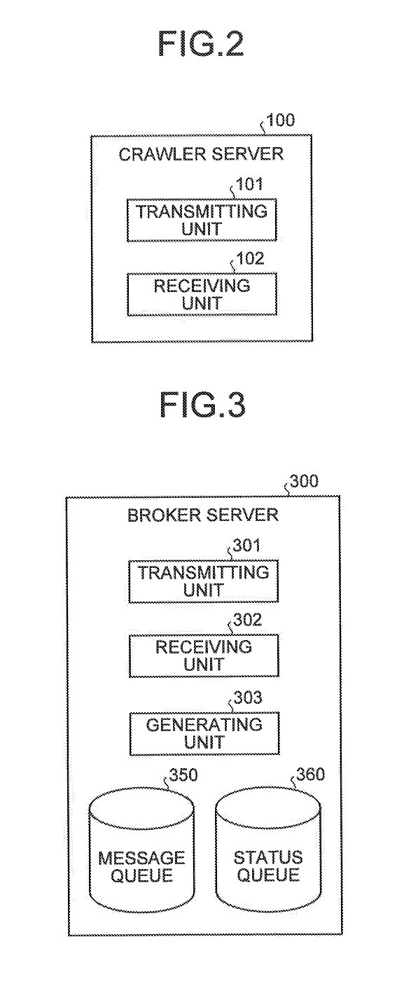

Next, examples of the functional configurations of the CS 100, the BSs 300, the FG 500, and the RS 600 will be described. FIG. 2 is a block diagram illustrating an exemplary configuration of the CS 100. As illustrated in FIG. 2, the CS 100 includes a transmitting unit 101 and a receiving unit 102.

The transmitting unit 101 transmits various information items to devices such as the DSs 200 and the BSs 300. For example, the transmitting unit 101 transmits a request for searching for a BS 300 associated with an oEPR of the FG 500 that manages facility equipment for which information is to be collected to the DSs 200. The transmitting unit 101 also transmits an acquisition request (hereinafter also referred to as an RQ) requesting to acquire information on the facility equipment to the BSs 300.

The receiving unit 102 receives various information items from devices such as the DSs 200 and the DSs 300. For example, the receiving unit 102 receives information (such as rEPR) identifying the BS 300 associated with an OEPR from the DSs 200. The receiving unit 102 also receives information (hereinafter also referred to as a RP) on the facility equipment transmitted as a response to the RQ from the BS 300.

The transmitting unit 101 and the receiving unit 102 may be implemented by making a processor such as a central processing unit (CPU) execute programs, that is, by software, may be implemented by hardware such as an integrated circuit (IC), or may be implemented by combination of software and hardware, for example.

FIG. 3 is a block diagram illustrating an exemplary configuration of the BS 300. As illustrated in FIG. 3, the BS 300 includes a transmitting unit 301, a receiving unit 302, a generating unit 303, the message queue (MQ) 350, and the status queue (SQ) 360.

The transmitting unit 301 (first transmitting unit) transmits various information items to devices such as the CS 100 and the RS 600. For example, the transmitting unit 301 transmits a RQ received from the CS 100 to the RS 600. The transmitting unit 301 also transmits a RP received from the RS 600 as a response to the RQ to the CS 100.

The receiving unit 302 (first receiving unit) receives various information items from devices such as the CS 100 and the RS 600. For example, the receiving unit 302 receives an RQ and information such as a status from the CS 100. The RQ is saved in the MQ 350 while the status is saved in the SQ 360. The receiving unit. 302 also receives a RP that is a response to the RQ from the RS 600.

Upon receipt of a new RQ from the CS 100, the generating unit. 303 generates, from information stored in the MQ 350, information to be transmitted as a response (RP) to the newly received RQ.

The transmitting unit 301, the receiving unit 302, and the generating unit 303 may be implemented by software, may be implemented by hardware, or may be implemented by combination of software and hardware, for example.

The MQ 350 and the SQ 360 can be implemented by any commonly used storage media such as a hard disk drive (HDD), an optical disk, a memory card, and a random access memory (RAM).

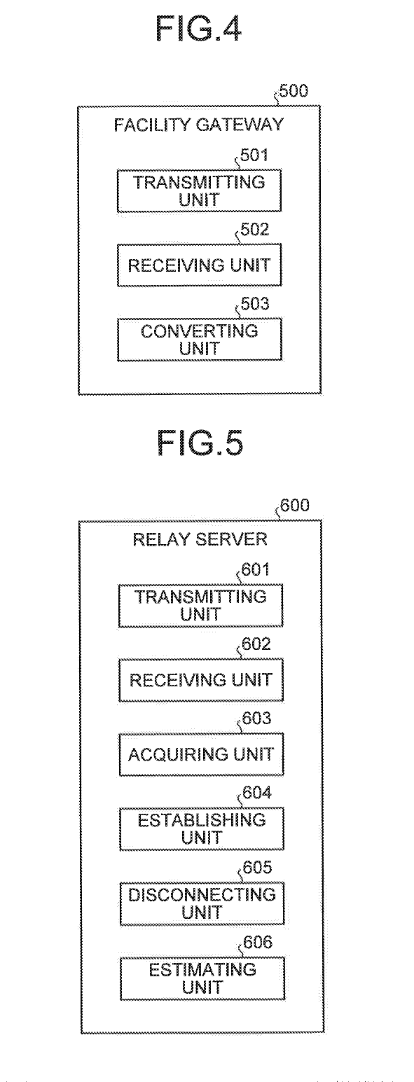

FIG. 4 is a block diagram illustrating an exemplary configuration of the FG 500. As illustrated in FIG. 4, the FG 500 includes a transmitting unit 501, a receiving unit 502, and a converting unit 503.

The transmitting unit 501 transmits various information items to devices such as the RS 600. For example, the transmitting unit 501 transmits information (RP) on the facility equipment acquired in response to a RQ transmitted from the RS 600 to the RS 600.

The receiving unit 502 receives various information items from devices such as the RS 600. For example, the receiving unit 502 receives a RQ from the RS 600.

The converting unit 503 converts a protocol for a network (facility network) to which the facility equipment is connected to a protocol allowing access via the Internet.

The transmitting unit 501, the receiving unit 502, and the converting unit 503 may be implemented by software, may be implemented by hardware, or may be implemented by combination of software and hardware, for example.

FIG. 5 is a block diagram illustrating an exemplary configuration of the RS 600. As illustrated in FIG. 5, the RS 600 includes a transmitting unit 601, a receiving unit 602, an acquiring unit 603, an establishing unit 604, a disconnecting unit 605, and an estimating unit 606.

The transmitting unit 601 (second transmitting unit) transmits various information items to devices such as the FG 500 and the BSs 300. For example, the transmitting unit 601 transmits a RP received from the FG 500 to the BS 300.

The receiving unit 602 (second receiving unit) receives various information items from devices such as the FG 500 and the BSs 300. For example, the receiving unit 602 receives a RQ from the BS 300.

The acquiring unit 603 acquires information (RP) requested by a RQ from the facility equipment via the FG 500. For example, the acquiring unit 603 acquires a RP by transmitting a RQ to the FG 500 via the transmitting unit 601 and receiving the RP transmitted as a response to the transmitted RQ via the receiving unit 602

The establishing unit 604 establishes communication with the BSs 300. The disconnecting unit 605 disconnects communication established with the BSs 300. The estimating unit 606 estimates the timing of acquiring information on the facility equipment.

The transmitting unit 601, the receiving unit 602, the acquiring unit 603, the establishing unit 604, the disconnecting unit 605, and the estimating unit 606 may be implemented by software, may be implemented by hardware, or may be implemented by combination of software and hardware, for example.

In the following, it is assumed that the devices described above know information on other devices as follows.

The RS 600 knows the FG 500 that the RS 600 manages.

The RS 600 knows one or more DSs 200.

The CS 100 knows an oEPR of the FG 500 that is likely to be accessed by the CS 100 and knows whether the FG 500 is within the FW 400 or outside thereof.

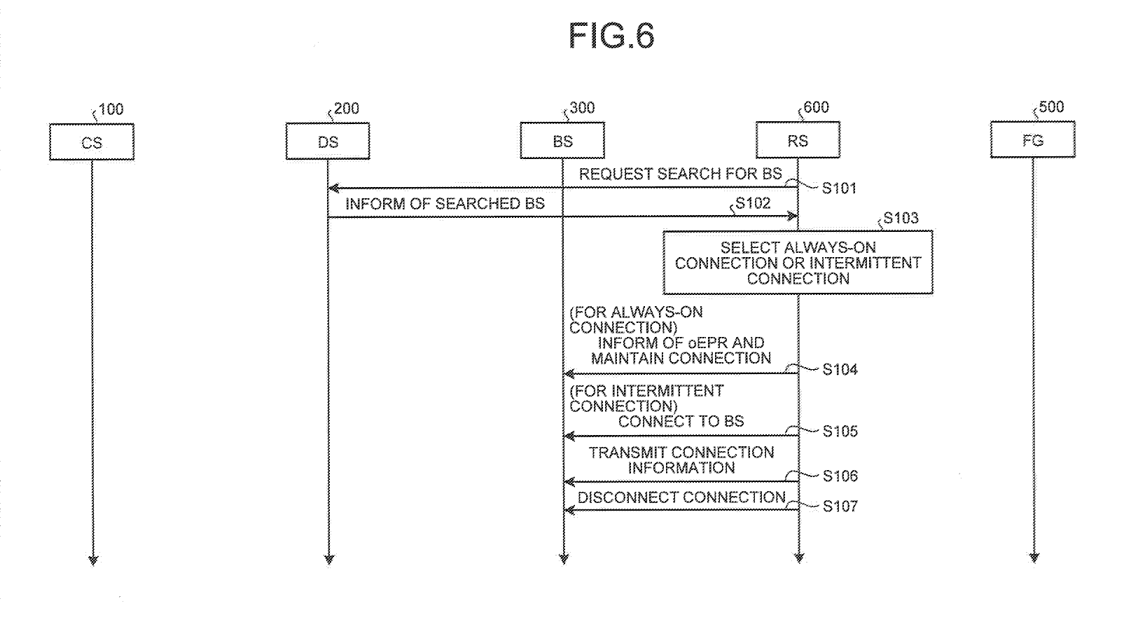

Next, details of various processes performed by the communication system 1 according to the embodiment having such a configuration will be described. FIG. 6 is a sequence diagram illustrating an example of a startup process according to the embodiment. The startup process is a process performed when the RS 600 is started.

The RS 600 requests the DSs 200 to search for a BS (step S101). At this point, the RS 600 informs the DSs 200 of the oEPR of the FG 500 that the RS 600 manages. The search for a BS is a process of searching for or determining a BS 300 to be connected to. Upon receipt of the request for searching a BS from the RS 600, the DSs 200 find an appropriate BS 300 and informs the rEPR of the BS 300 (step S102). The rEPR may be determined before searching for the BS 300. Alternatively, the BS 300 itself may determine the rEPR during the search for the BS 300. Still alternatively, the DSs 200 may determine the rEPR and assign the determined rEPR to the found BS 300.

The following method can be applied as a suitable method for searching for a BS 300.

(1) A BS 300 to be searched for is determined and informed by using a distributed hash table (DHT) or the like. The oEPR, for example, is used as an input value for calculating a hash value.
(2) The BSs 300 are completely independent, and the DSs 200 inform of a specific BS 300 according to a certain condition. For example:

the DSs 200 guess a network distance between each BS 300 and the RS 600, identify the BS 300 with the shortest network distance to the RS 600, and inform of the BS 300;

the DSs 200 manage the statuses (such as loads) of the BSs 300, identify the BS 300 with the status satisfying a predetermined condition (with the smallest load, for example), and informs of the BS 300; and

a BS 300 is selected according to a result of taking the both (the network distance and the status) into consideration, and the selected BS 300 is informed.

(3) A result of routing assuming that the BSs 300 and the DSs 200 operate on the same nodes and using the DHT including the BSs 300 is informed.

The DS 200 that has searched for the BS 300 and the found BS 300 store the rEPR of the found BS 300 and the oEPR of the FG 500 managed by the RS 600 that has requested the search in association with each other. Note that the oEPR and rEPR may always be equal when the oEPR present within the FW 400 can be freely selected. For example, the same value as the found rEPR may be used as the oEPR.

Alternatively, the RS 600 may have an association table in advance in a case where the oEPR and the address for actually accessing the FG 500 are different. For example, it is assumed that the actual oEPR of the FG 500 is “http://fg1.global.example.com/” while the URL by which the FG 500 actually provides services is “http://fg1.local.example.com/”. In this case, the RS 600 may know that the oEPR and the URL are associated with each other, and may be capable of transmitting a request for accessing the oEPR to the associated. URL “http://fg1.local.example.com/”.

As a method for assigning the rEPR to the BS 300, Dynamic DNS Update (RFC 2136), for example, can be used.

Note that the communication system 1 may have a configuration in which the DSs 200 are not included. In this case, the association between the oEPR, the rEPR and the BS 300 may be determined in advance, for example.

The RS 600 informed of the rEPR of the BS 300 selects and performs either one of the two connections of the always-on connection and the intermittent connection to the informed BS 300 (rEPR) (step S103). Note that the RS 600 may switch between the connections at an arbitrary point.

If the always-on connection is selected, the RS 600 informs the BS 300 of the oEPR and maintains the connection with the BS 300 (step S104). For the maintenance of connection, Comet or WebSocket (RFC 6455), for example, can be used. The RS 600 maintains connection with the BS 300, and if the connection is disconnected, immediately reconnects thereto. If it can be determined that the circumstances are that the always-on connection is not permitted according to a policy of the FW 400 or the like, the RS 600 may switch the connection to the intermittent connection.

If the intermittent connection is selected, the RS 600 connects to the BS 300 by the establishing unit 604 (step S105), thereafter leaves connection information in the SQ 360 by the transmitting unit 601 (step S106), and disconnects the connection by the disconnecting unit 605 (step S107).

As the connection information, information on the intermittent connection can be used. For example, specification information specifying the timing of information acquisition such as the estimated time at which the RS 600 is to connect to the BS 300 next and a time interval until the next connection can be used as the connection information.

The RS 600 may use an existing protocol or may design a unique protocol as a method for accessing each queue (MQ 350, SQ 360). For BACnet/WS, for example, it is conceivable to use paths “/.sysinfo/H(oEPR)/SQ” and “/.sysinfo/H(oEPR)/MQ” and perform. “getValue( )” and “setValue( )” on these paths. Note that H(x) represents a hash value of x. Any methods such as SHA1 conventionally used can be applied as a method for calculating the hash value.

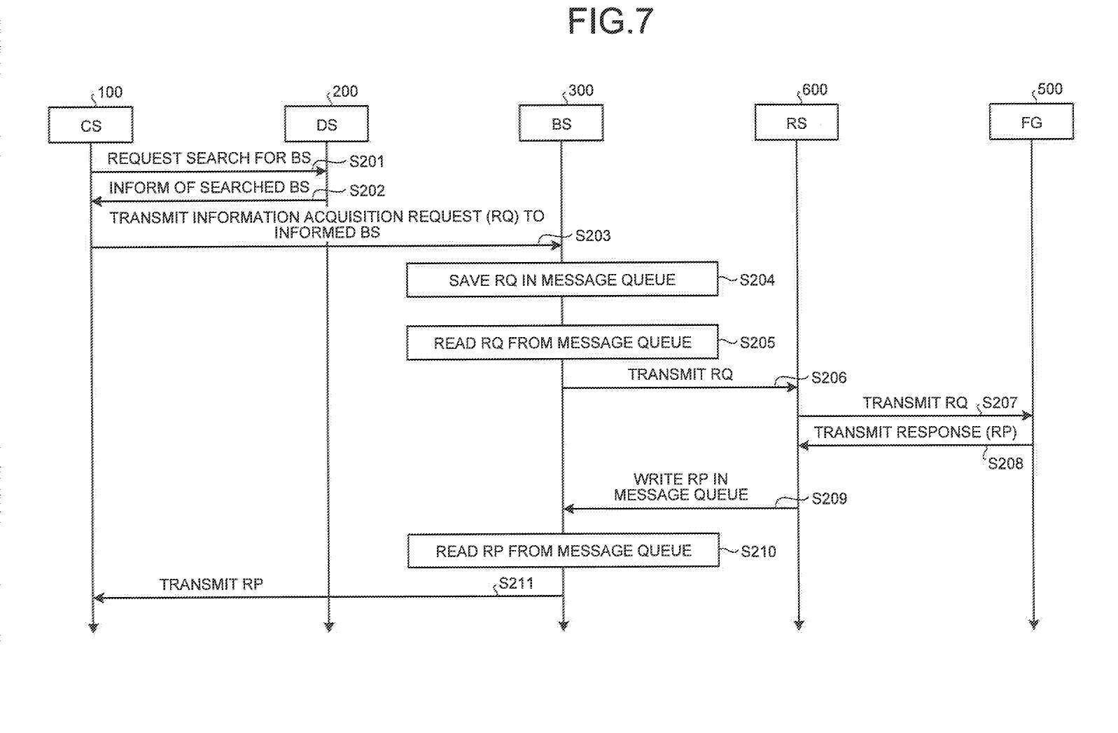

FIG. 7 is a sequence diagram illustrating an example of a data collection process according to the embodiment. The data collection process in FIG. 7 represents a process when the RS 600 performs always-on connection to the BS 300.

Note that when the FG 500 to communicate with is present outside of the FW 400, the CS 100 can connect to the oEPR of the FG 500 to transmit a RQ thereto and receive a RP as a response to the RQ. Whether or not the FG 500 is outside of the FW 400 may be determined in advance as the aforementioned assumption or it may be determined that the FG 500 is within the FW 400 when connection is attempted and an error such as timeout occurs. The process of FIG. 7 is performed when the FG 500 to communicate with is within the FW 400.

If the FG 500 to communicate with is within the FW 400, the CS 100 transmits a request for searching for a BS 300 to the DSs 200 so as to acquire the BS 300 associated with the oEPR of the FG 500 (step S201). The DSs 200 refer to information associated in advance by the process of FIG. 6 or the identifies the rEPR associated with the oEPR, and informs the CS 100 of the identified rEPR (step S202).

The CS 100 transmits an information acquisition request (RQ) to the obtained BS 300 (step S203). The BS 300 saves the RQ into the MQ 350 associated with the oEPR requested by the RQ upon receipt of the RQ (step S204).

Since FIG. 7 illustrates an example of always-on connection, the BS 300 immediately reads out the RQ from the MQ 350 (step S205). The BS 300 transmits the RQ additionally with the information on the requested oEPR to the RS 600 to which the BS 300 is connected, and waits for a RP (step S206). At this point, the BS 300 waits without returning a RP to the CS 100.

Upon receipt of the RQ, the RS 600 transmits the RQ to the FG 500 having the requested oEPR, and waits for a RP (step S207). The FG 500 to which the RQ is transmitted processes the RQ, and returns a RP to the RS 600 (step S208). As a result, the RS 600 (the acquiring unit 603) can acquire information (RP) requested by the RQ.

Upon receipt of the RP, the RS 600 writes the received RP into the MQ 350 of the associated BS 300 (step S209). The BS 300 immediately reads out the RP from the MQ 350 (step S210), and passes the RP as a response to the CS 100 (step S211).

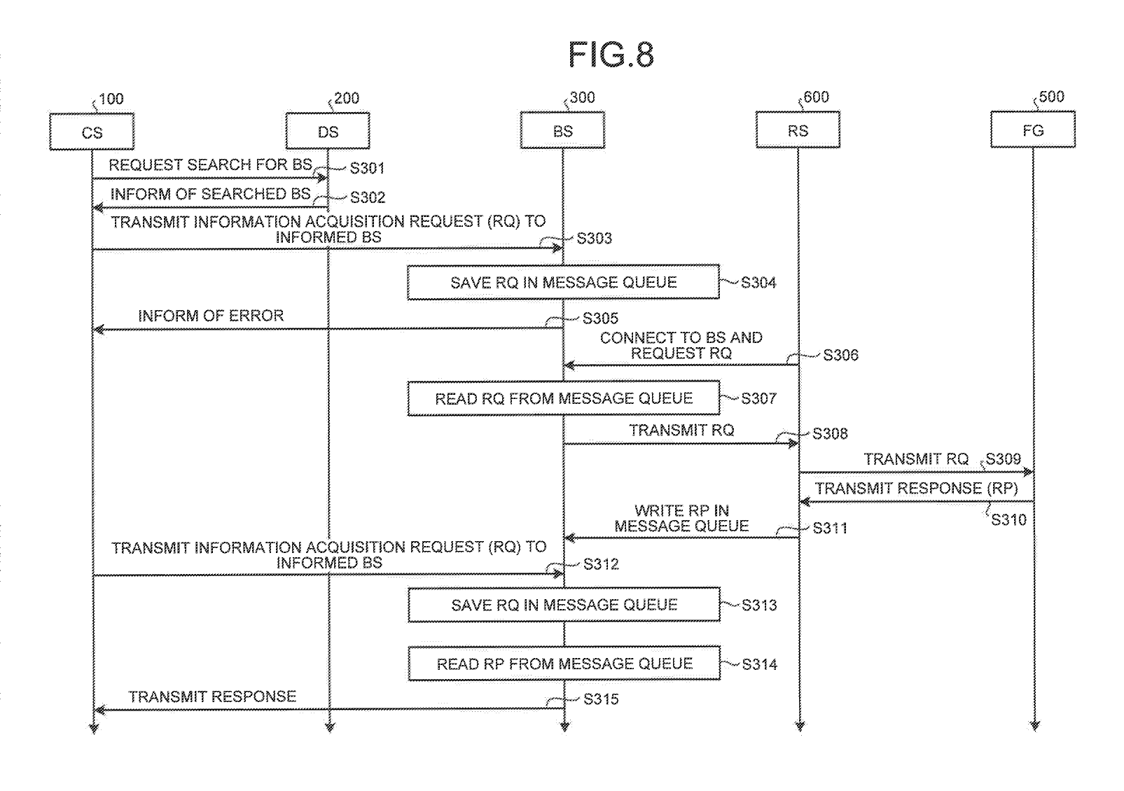

FIG. 8 is a sequence diagram illustrating another example of a data collection process according to the embodiment. The data collection process in FIG. 8 represents a process when the RS 600 performs intermittent connection to the BS 300. Since the processing in steps S301 to S304 is the same as that in steps S201 to S204 in FIG. 7, the description thereof will not be repeated.

In intermittent connection, after an RQ is saved in the MQ 350 (step S304), the CS 100 is informed of an error indicating that the response PP does not exist (step S305). When HTTP is used, for example, the BS 300 informs the CS 100 of “504 Gateway Timeout” or the like.

In intermittent connection, the RS 600 periodically connects to the BS 300 to check the MQ 350, for example. That is, the RS 600 establishes connection with the BS 300 by the establishing unit 604, and requests for reading out the RQ from the MQ 350 by the transmitting unit 601 (transmission request) (step S306). At this point, the RS 600 may write connection information (specification information) such as the estimated time of the next connection into the SQ 360.

The BS 300 reads out the requested RQ from the MQ 350 (step S307), and transmits the read RQ to the RS 600 (step S308). Alternatively, the RS 600 may be configured to directly access the MQ 350 to read out the requested RQ. Furthermore, the RS 600 may be configured to directly access the SQ 360 to write the connection information therein.

The RS 600 transmits the received RQ to the FG 500 to communicate with (step S309). The FG 500 to which the RQ is transmitted processes the RQ, and returns a RP to the RS 600 (step S310). Upon acquiring the RP, the RS 600 (the acquiring unit 603) reconnects to the BS 300 by the establishing unit 504, and writes the RP into the MQ 350 by the transmitting unit 601 (step S311).

In intermittent connection, the CS 100 performs the following process. The CS 100 periodically connects to the BS 300, and transmits the RQ, for example (step S312). The BS 300 writes the received RQ into the MQ 350 (step S313). If a message is present in the MQ 350 (the queue into which messages from the FG 500 to the CS 100 are written) and the message is suitable for a response to the RQ, the BS 300 reads out the message as a RP (step S314). The BS 300 transmits the read RP to the CS 100 (step S315). The BS 300 deletes the read RP (message) from the MQ 350.

If a relevant message still does not exist in the MQ 350 at this point, the BS 300 returns an appropriate error (similarly to step S305). If there is a plurality of RPs in response to the same SQ in the MQ 350, the BS 300 returns the newest RP to the CS 100 and deletes the other RPs from the SQ 350.

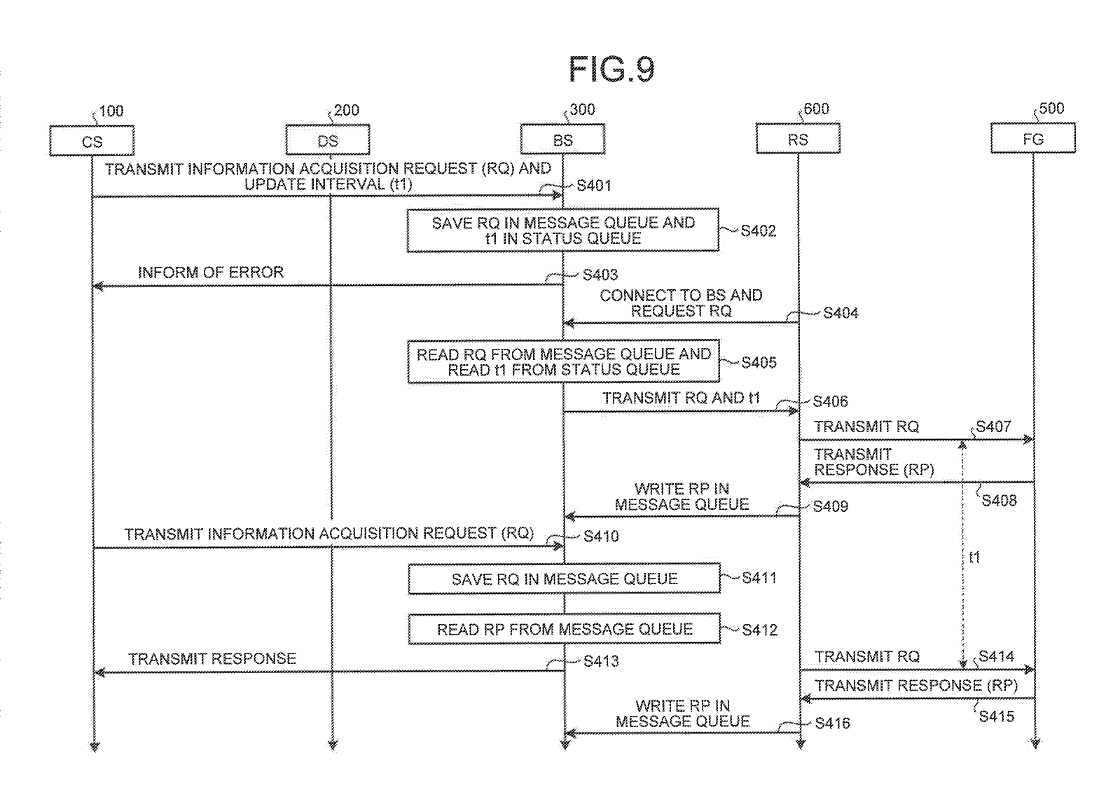

FIG. 9 is a sequence diagram illustrating another example of a data collection process according to the embodiment. The data collection process in FIG. 9 represents a process when the RS 600 performs intermittent connection to the BS 300 and the connection information for the intermittent connection can be adjusted.

For example, the CS 100 may read the SQ 360 to know when the RS 600 is next scheduled to connect to the BS 300. As a result, the CS 100 can appropriately set the next time to transmit the RQ and receive a response at appropriate timing even during the intermittent connection. Furthermore, the CS 100 may insert a desired update interval in the SQ 350. FIG. 9 illustrates an example of a process in such a case. Note that the steps S301 and S302 in FIG. 8 are not illustrated in FIG. 9. That is, it is assumed that the CS 100 already knows the rEPR associated with the oEPR.

The CS 100 transmits an update interval t1 together with an information acquisition request (RQ) to the BS 300 (step S401). The BS 300 saves the RQ in the MQ 350 associated with the oEPR requested by the RQ, and saves the update interval t1 as the connection information (specification information) in the SQ 360 (step S402).

Since the processing in steps S403 to S404 is the same as that in steps S305 to S306 in FIG. 8, the description thereof will not be repeated.

The BS 300 reads out the requested RQ from the MQ 350 and reads out the update interval t1 from the SQ 360 (step S405). The BS 300 transmits the read RQ and t1 to the RS 600 (step S406).

Since the processing in steps S407 to S413 is the same as that in steps S309 to S315 in FIG. 8, the description thereof will not be repeated.

Since the update interval t1 is specified in the SQ 360 in the example of FIG. 9, the RS 600 stores the RQ set in the MQ 350 at this point in an internal storage unit (not illustrated) or the like. The RS 600 transmits the stored RQ to the FG 500 at the time intervals specified as the update interval t1, and writes a RP acquired from the FG 500 into the MQ 350 of the BS 300 (steps S414 to S416).

Note that the CS 100 may specify 0 as the update interval t1 to stop the periodical transmission of RQ to the FG 500, for example.

The CS 100 may save an update time instead of the update interval in the SQ 360. In this case, the RS 600 performs the following process in addition to the normal process in the case of intermittent connection.

The RS 600 periodically connects to the BS 300 to check the SQ 360. If an update time is specified in the SQ 360, the RQ set in the MQ 350 at that point (at the point when the SQ 360 is checked) is stored in a storage unit or the like. The RS 600 transmits the stored RQ to the FG 500 at the specified update time, and writes a RP acquired from the FG 500 into the MQ 350 of the BS 300.

Note that if the CS 100 specifies neither of the update interval and the update time in the SQ 360, the RS 600 may be configured to estimate the update interval or the update time. The estimating unit 606 has a function of estimating the timing of acquiring information in this manner.

The estimating unit 606 estimates an update interval by using a simple moving average of the intervals at which RQs are transmitted, for example. The method for estimation performed by the estimating unit 606 is not limited thereto. For example, a method of statistical estimation from transmission times of previous RQs may be used. For example, the estimating unit 606 may statistically analyze a pattern of transmission of RQs such as distribution of 95% in a with of 60 seconds with the center at five past the hour, and estimate the transmission interval (one hour, for example) or the transmission time (five past the hour, for example) of the RQs on the basis of the analysis result.

If the RS 600 can estimate that the CS 100 periodically transmits the same RQ (for example, requests information on a point A on the hour every hour), the RS 600 performs the following process in addition to the normal process in the case of intermittent connection.

If the transmission time of a certain RQ transmitted by the CS 100 can be estimated, the RS 600 stores the RQ in a storage unit or the like. The RS 600 transmits the RQ to the FG 500, and periodically measures the time from acquisition of the RE from the FG 500 to writing the RP into the MQ 350 of the BS 300. The RS 600 stores the measured time in a storage unit or the like, and calculates the estimated processing time from the stored time. The processing time may be calculated by the moving average or the like each time the time is measured, or may be calculated by periodical estimation. The calculated time is represented by “FG−BS−RTT”.

The RS 600 transmits the RQ to the FG 500 before the time obtained by subtracting “FG−BS−RTT” from the estimated transmission time of the CS 100, acquires a RP from the FG 500, and writes the RP into the MQ 350 of the BS 300. As a result, the RP can be present in the MQ 350 at the point when the CS 100 transmits the RQ to the BS 300. That is, the BS 300 can return the RP in response to the RQ to the CS 100.

The RS 600 may periodically check the MQ 350 to confirm that a response based on the estimation of the transmission time is used. For example, if a response is not used for a sufficiently long time, the estimation may be regarded as unsuccessful and the RS 600 may delete the corresponding RP from the MQ 350. Thereafter, the RS 600 may attempt estimation again.

The BS 300 may estimate the transmission time of the CS 100 in place of the RS 600. In this case, the BS 300 records the desired next update time in the SQ 360 and informs the RS 600 of the update time in place of the CS 100.

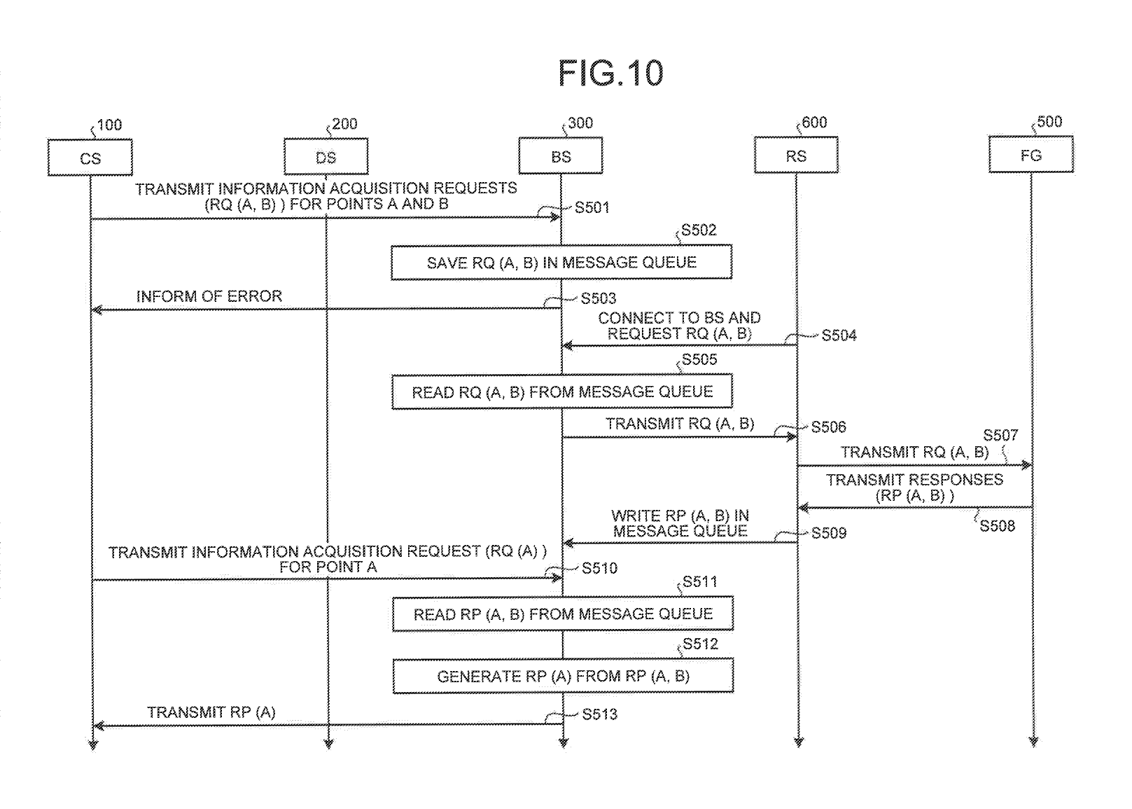

FIG. 10 is a sequence diagram illustrating another example of a data collection process according to the embodiment. The data collection process in FIG. 10 represents a process when the RS 600 performs intermittent connection to the BS 300 and further a response (RP) in response to a RQ can be generated from information stored in the MQ 350.

For example, if a RQ from the CS 100 requests for “acquisition of information on a point A” and a response already present in the MQ 350 is “information on the point A and a point B”, the BS 300 may generate and return a RP containing only the result for the point A. FIG. 10 illustrates an example of a process in such a case. A point is information indicating the position of a piece of facility equipment managed by the FG 500, for example.

The CS 100 transmits a RQ (hereinafter referred to as a RQ (A, B)) requesting to acquire information on the point A and the point B to the BS 300 (step S501). The BS 300 saves the RQ(A, B) in the MQ 350 (step S502). If a RP (hereinafter referred to as RP(A, B) in response to the RQ(A, B) is not saved, the BS 300 informs the CS 100 of an error (step S503).

Since the processing in steps S504 to S509 is the same as that in steps S306 to S311 in FIG. 8, the description thereof will not be repeated.

It is assumed here that the CS 100 transmits a RQ(A) requesting to acquire information on the point A to the BS 300 (step S510). In this case, the BS 300 reads out the RP (the RP (A, B) in this example) already saved in the MQ 350 and associated with the oEPR requested by the RQ, for example (step S511). The generating unit 303 of the BS 300 generates a RP(A) from the read RP(A, B) (step S512). For example, if information indicating on which point the information is contained in the RP, the generating unit 303 can refer to the information to extract information (RP) acquired from the desired point.

The BS 300 transmits the generated RP(A) to the CS 100 (step S513).

If the RQ requested by the CS 100 does not completely match the RP already stored in the MQ 350 but an appropriate RP can be partially generated from the stored RP, the BS 300 (the generating unit 303) may generate the appropriate RP from the RP saved in the MQ 350. For example, if a RQ from the CS 100 requests for “acquisition of information on a point A and a point B” and a RP already saved in the MQ 350 is “information on the point A”, the BS 300 may generate and return a RP containing a response for the point A and an appropriate partial error for the point B.

If the BS 300 saves a history of RPs for a certain period and a result for the point B is present therein, the BS 300 may generate and return a RP containing the response for the point A and the previous response for the point B by using the result of acquisition of previous information on the point B.

If the BS 300 can correctly modify additional information, the BS 300 may return modified additional information. For example, it is assumed that the content of a RQ from the CS 100 is information on a point A and a difference between the time at which the information on the point A is acquired and the current time (for example, how many seconds ago the data are acquired from the facility equipment. If the FG 500 now acquires data from the facility equipment according to a request from the RS 600 (without caching or the like) and changes the response, the response from the RS 600 to the BS 300 becomes (information on the point A, 0 second) (corresponding to step S509). The BS 300 saves the response in the MQ. In this process, it is assumed that the BS 300 stores the receiving time of the response. It is assumed that the CS 100 requests for “the difference between the time at which the information on the point A is acquired and the current time” again 30 seconds later (corresponding to step S510). The BS 300 can modify the difference between the acquisition time and the current time from 0 seconds to 30 seconds based on the receiving time of the associated response. The BS 300 may thus modify the response (information on the point A, 0 seconds) saved in the MQ and return (information on the point A, 30 seconds) to the CS 100.

As described above, with the communication system according to the embodiment, a relay device (BS) located outside of a firewall can be accessed from a relay device (RS) located within the firewall. A communication device on the Internet (outside of the firewall) can therefore acquire information on a device within the firewall.

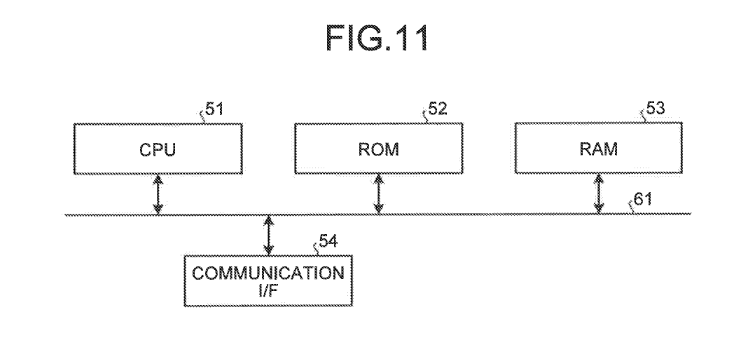

Next, the hardware configurations of the respective devices (CS, DS, BS, RS, and FG) of the communication system according to the embodiment will be described with reference to FIG. 11. FIG. 11 is an explanatory diagram illustrating a hardware configuration of the communication system according to the embodiment.

Each device of the communication system according to the embodiment includes a control unit such as a central processing unit (CPU) 51, a storage unit such as a read only memory (ROM) 52 and a random access memory (RAM) 53, a communication interface 54 for connecting to a network and performing communication, and a bus 61 connecting the respective units.

Programs to be executed by the respective devices of the communication system according to the embodiment are embedded in advance in the ROM 52 or the like and provided therefrom.

Alternatively, the programs to be executed by the devices of the communication system according to the embodiment may be recorded on a computer readable recording medium such as a compact disk read only memory (CD-ROM), a flexible disk (FD), a compact disk recordable (CD-R), and a digital versatile disk (DVD) in a form of a file that can be installed, or executed, and provided as a computer program product.

Still alternatively, the programs to be executed by the devices of the communication system according to the embodiment may be stored on a computer system connected to a network such as the Internet, and provided by being downloaded via the network. Still alternatively, the programs to be executed by the devices of the communication system according to the embodiment may be provided or distributed through a network such as the Internet.

The programs to be executed by the devices of the communication system according to the embodiment can cause a computer to function as the units of each of the devices described above. In the computer, the CPU 51 can read out the programs from the computer readable recording medium onto a main storage device and execute the programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system comprising:
a first relay device located outside of a firewall; and
a second relay device located within the firewall, wherein
the first relay device comprises:
a first receiving unit configured to receive a request for acquiring information on an information processing device within the firewall from a communication device and receive the information acquired from the information processing device from the second relay device;
a storage unit configured to store therein the acquisition request; and
a first transmitting unit configured to transmit the acquisition request stored in the storage unit to the second relay device and transmit the information received from the second relay device to the communication device, and
the second relay device comprises:
a second receiving unit configured to receive the acquisition request transmitted from the first relay device;
an acquiring unit configured to acquire information requested by the acquisition request from the information processing device; and
a second transmitting unit configured to transmit the acquired information to the first relay device.

2. The system according to claim 1, wherein
the second relay device further comprises:
an establishing unit configured to establish communication with the first relay device; and
a disconnecting unit configured to disconnect the communication,
after the communication is established, the second transmitting unit further transmits a transmission request for transmitting the acquisition request to the first relay device, and
the disconnecting unit disconnects the communication after the second receiving unit receives the acquisition request transmitted from the first relay device in response to the transmission request.

3. The system according to claim 1, wherein
the second relay device further comprises:
an establishing unit configured to establish communication with the first relay device; and
a disconnecting unit configured to disconnect the communication,
after the communication is established, the second transmitting unit transmits the acquired information to the first relay device, and
the disconnecting unit disconnects the communication after transmitting the acquired information.

4. The system according to claim 1, wherein
the first receiving unit further receives specification information specifying timing of acquiring the information from the communication device,
the first transmitting unit further transmits the specification information to the second relay device, and
the acquiring unit acquires information from the information processing device at the timing specified by the specification information.

5. The system according to claim 4, wherein the specification information is information specifying an interval of time at which the information is acquired.

6. The system according to claim 4, wherein the specification information is information specifying time at which the information is acquired.

7. The system according to claim 1, wherein
the second relay device further comprises an estimating unit configured to estimate timing of acquiring the information, and
the acquiring unit acquires the information from the information processing device at the estimated timing.

8. The system according to claim 1, wherein
the storage unit further stores therein the information received from the second relay device,
the first relay device further comprises a generating unit configured to generate, from the information stored in the storage unit, information to be transmitted as a response to a newly received acquisition request for acquiring information on the information processing device from the communication device when the acquisition request is newly received, and
the first transmitting unit transmit the generated information as the response to the newly received acquisition request to the communication device.

9. A communication method performed by a communication system including: a first relay device located outside of a firewall; and a second relay device located within the firewall, the method comprising:
receiving a request for acquiring information on an information processing device within the firewall from a communication device by the first relay device;
storing the acquisition request in a storage unit by the first relay device;
transmitting the acquisition request stored in the storage unit to the second relay device by the first relay device;
receiving the acquisition request transmitted from the first relay device by the second relay device;
acquiring information requested by the acquisition request from the information processing device by the second relay device;
transmitting the acquired information to the first relay device by the second relay device;
receiving the information acquired from the information processing device from the second relay device by the first relay device; and
transmitting the information received from the second relay device to the communication device by the first relay device.
